(19) United States
(12) Patent Application Publication
(10) Pub. No.: US 2010/0163500 A1
(43) Pub. Date: Jul. 1, 2010

(54) Measuring Tape Notepad

(76) Inventor: Joseph Megow, La Mesa, CA (US)

Correspondence Address: Karl M. Steins;Steins & Associates, Suite 120, 2333 Camino del Rio South, San Diego, CA, 92108, US

(21) Appl. No.: 12/345,559

(22) Filed: Dec. 29, 2008

(51) Int. Cl. A47F 7/14; G01B 3/10

(52) U.S. Cl. 211/50; 33/760

(57) ABSTRACT

A Measuring Tape Notepad is disclosed. The notepad is attachable to the side of the housing of a conventional measuring tape. The notepad assembly is designed to fit a wide variety of measuring tape configurations. The assembly includes a durable, hard, non-scratching writing surface, with a pencil clip protruding from its face. The clip for the writing implement may also be available with a lanyard or chain interconnecting the writing implement with the notepad assembly. The notepad is available in a variety of different shapes, including rectangular and round, among others.

### BACKGROUND OF THE INVENTION

1. Field of the Invention

This invention relates generally hand tools and accessories therefor and, more specifically, to a Measuring Tape Notepad.

2. Description of Related Art

Recoiling measuring tapes are one of many pieces of standard equipment used by construction tradespersons; an example of such measuring tape is depicted in FIGS. 1A and 1B. FIGS. 1A and 1B are outside and inside perspective views, respectively, of a conventional measuring tape.

The measuring tape 20 is typically defined by a substantially rectangular housing 24 made from a durable material such as metal or plastic. The housing 24 is hollow inside in order to accommodate a coiled flat metal tape 8 (shown partially extended here) within it. An end tab 6 located at the tip end of the tape 8 prevents the tape 8 from being inadvertently over-retracted within the housing 24.

The housing 24 has a substantially flat outside face 24, as well as a substantially flat inside face 2 in generally parallel orientation thereto. In most cases, there is a belt clip 4 extending from the inside face 2, so that the user can clip the measuring tape 20 to his or her belt in order to make it readily available for use.

The purpose of the present invention is to capitalize on the ready availability of the conventional measuring tape 20 by adding a note-taking feature. There have been other prior note pad and the like related to measuring tapes, but none a simple, yet functional as the assembly of the present invention. Specifically, Zayat, Jr., U.S. Pat. No. 5,845,413 discloses a “Note Pad Holder for a Tape Measure” that is a pouch for the tape measure, the pouch having a sleeve for a notepad. Gardenhour, Jr. et al., U.S. Pat. No. 5,575,506 discloses an “Erasable Writing Pad” that clips on the tape measure belt clip. Hintz, Jr., U.S. Pat. No. 5,459,942 discloses a “Notation Plate” that is a curved writing surface for attachment to the outside face 26 of the tape measure. Sill, U.S. Pat. No. 5,079,851 has a central recessed portion in the outside face 26 of the tape measure that is intended for writing upon.

Additional examples of the prior art include Bolson, U.S. Pat. No. 4,766,673, having a “Tape Measure System” that is a multi-function device including memo pads on its outside face 26. Dynan is a “Tape Measure” that has a built-in storage pocket within the tape measure housing for holding a solid-surface writing tablet therein.

The aforementioned measuring tape 20 is extremely functional and handy, but would be improved if it was further equipped with a writing surface and implement.

### SUMMARY OF THE INVENTION

In light of the aforementioned problems associated with the prior devices and combinations, it is an object of the present invention to provide a Measuring Tape Notepad. The notepad should be attachable to the side of the housing of a conventional measuring tape. It is an object that the notepad assembly fit a wide variety of tape measure configurations. The assembly should include a durable, hard, non-scratching writing surface, with a pencil clip protruding from its face. The clip for the writing implement should also be available with a lanyard or chain interconnecting the writing implement with the notepad assembly. The notepad should be available in a variety of different shapes, including rectangular and round.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, of which:

FIGS. 1A and 1B are right and left perspective views of a conventional tape measure;

FIG. 2 is a right perspective view of the tape measure of FIGS. 1A and 1B having a preferred embodiment of the notepad assembly of the present invention attached thereto;

FIG. 3 is an exploded right perspective view of the combination of FIG. 2;

FIG. 4 is a left perspective view of the notepad assembly of FIGS. 2 and 3;

FIG. 5 is a front view of the notepad assembly of FIGS. 2-4; and

FIG. 6 is a perspective view of a preferred adhesive pad of the assembly of FIGS. 2-5.

### DETAILED DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the generic principles of the present invention have been defined herein specifically to provide a Measuring Tape Notepad.

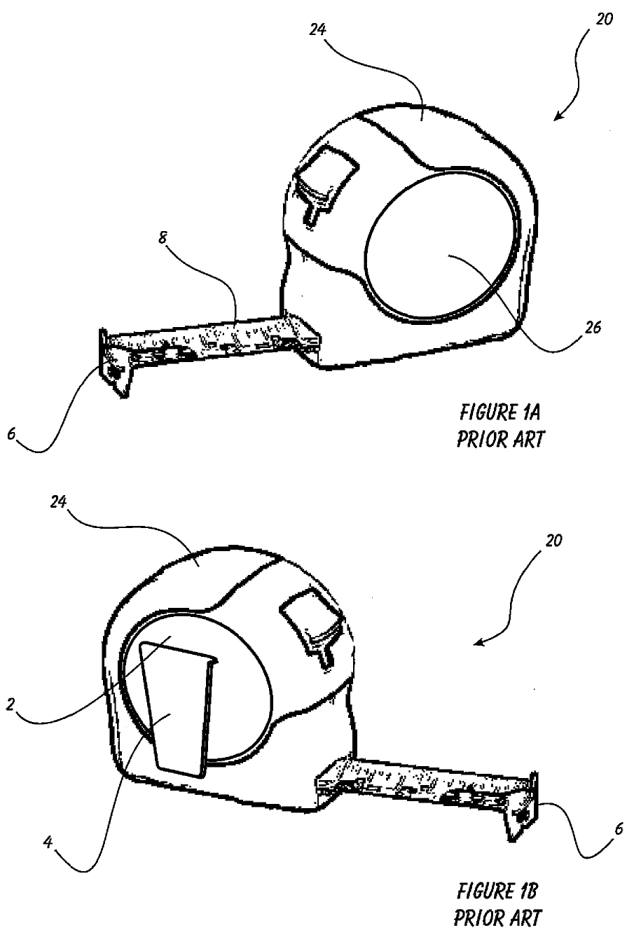

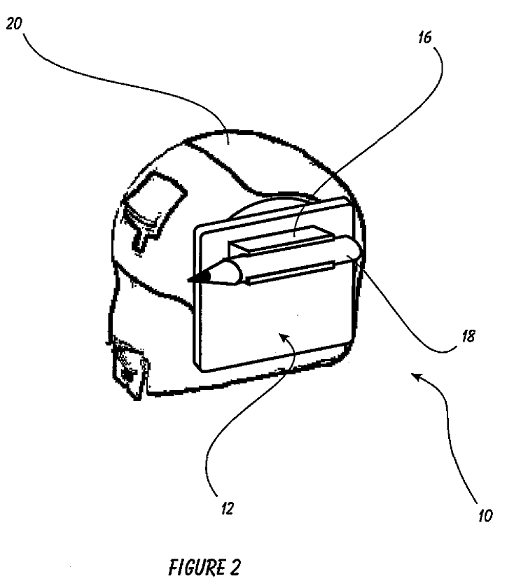

The present invention can best be understood by initial consideration of FIG. 2. FIG. 2 is a right perspective view of the tape measure 20 of FIGS. 1A and 1B having a preferred embodiment of the notepad assembly 10 of the present invention attached thereto. The notepad assembly 10 comprises an inscription member 12 that has a clip 16 for releasibly holding a writing implement 18 therein protruding from its top surface 14.

The inscription member 12 is preferably made from a piece of thin, flat, rigid material, with a very durable top surface 14. While shown as shaped as a rectangle here, other shapes may be provided. Also, the inscription member 12 may be rectangular, but have corners that are more rounded than depicted.

One preferred material is Formica™, due to its scratch resistance and ease of cleaning. The clip 16 is either a molded part of the inscription member 12, or it is attached thereto. A writing implement 18, such as a pencil, pen, crayon or the like will be releasibly held in place by the clip 16 if the implement 18 is snapped into it. When the user wishes to record something, such as a dimension or a parts list, etc., he or she need simply unclip the tape measure 20 from their belt (if it's clipped), turn the top surface 14 of the inscription member 12 to face the user, unclip the writing implement 18, and then write on the top surface 14 of the inscription member 12. The writing implement 18 can then be re-clipped into the clip 16. In other versions, a chain or other lanyard (not shown) may interconnect the writing implement 18 to the inscription member 12 or clip 16.

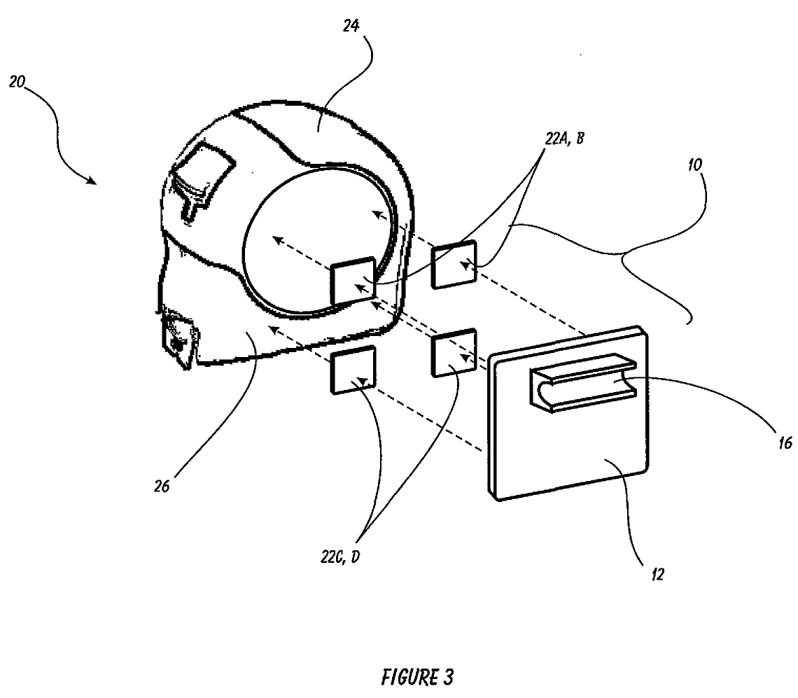

Because the top surface 14 of the inscription member 12 is made from hard, impervious material, any writing inscribed there can be easily wiped off for re-use. FIG. 3 depicts the manner in which the notepad is affixed to the tape measure 20.

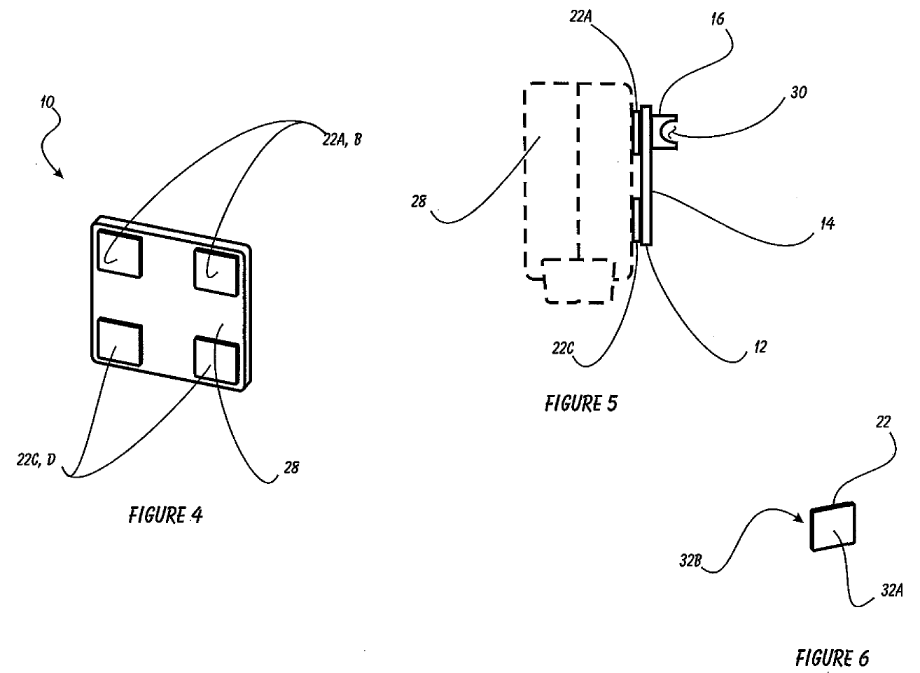

FIG. 3 is an exploded right perspective view of the combination tape measure 20 and notepad assembly 10 of FIG. 2. The notepad assembly 10 attaches to the outside face 26 of the tape measure 20 housing 24 via a variety of semi-permanent means. The preferred method is via four adhesive pads 22A-22D placed between the outside face 26 and the back surface (not shown) of the inscription member 12. The pads 22A-22D are to be placed near the four corners of the inscription member 12. FIG. 4 depicts this arrangement.

FIG. 4 is a left perspective view of the notepad assembly 10 of FIGS. 2 and 3. As shown here, there is one adhesive pad 22A-22D attached to the back surface 28 of the inscription member 12, adjacent to each of its four corners. FIG. 5 is a front view of the notepad assembly 10 of FIGS. 2-4. As shown, the clip 16 has a substantially flat bottom where it meets the top surface 14 of the inscription member 12. Its top surface includes an elongate arcuate bore for accepting a writing implement having the appropriately-sized diameter and cross-section therein. Although the notepad assembly 10 is designed to be an add-on device for a conventional tape measure, the adhesive pads 22A-22D keep the inscription member 12 firmly attached to the housing of the tape measure, without requiring any modification to either the inscription member 12 or the tape measure.

FIG. 6 is a perspective view of a preferred adhesive pad 22 of the assembly of FIGS. 2-5. These pads 22 (the generic description of the previously-identified 22A-22D) are conventional double-sided adhesive pads or tape. There is a substrate of foam or other pliable material, with adhesive applied to the first and second outer surfaces 32A, 32B. Generally, these pads 22 would be provided to the user with removable protective skins in place over the adhesive surfaces 32A, 32B. The user then removes the protective skins and adheres the pads 22 to the back of the inscription member and the tape measure (see FIG. 5).

Those skilled in the art will appreciate that various adaptations and modifications of the just-described preferred embodiment can be configured without departing from the scope and spirit of the invention. Therefore, it is to be understood that, within the scope of the appended claims, the invention may be practiced other than as specifically described herein.

What is claimed is:

1. A notepad assembly, comprising:
a substantially flat, generally rectangular inscription member defined by a top surface and a back surface; and
at least two adhesive pads defined by an adhesive material applied to at least one of their exposed surfaces protruding from said back surface.

2. The assembly of claim 1, further comprising a clip configured to releasibly retain an elongate member extending from said inscription member.

3. The assembly of claim 2, wherein said clip is defined by a back surface attached to said top surface, said clip releasable retention feature being an elongate arcuate bore substantially along its length.

4. The assembly of claim 3, wherein said top surface is a scratch-resistant material.

5. The assembly of claim 4, wherein said adhesive pads comprise a thickened pliable substrate having first and second surfaces, each said surface coated with said adhesive material.

6. The assembly of claim 5, comprising four said adhesive pads.

7. The assembly of claim 6, wherein one of each said adhesive pads is attached to said back surface of said inscription member adjacent to each of the four corners of said generally rectangular shape.

8. A combination tape measure and notepad, comprising:
a tape measure defined by a housing having a coiled tape therein, said housing further defined by an outside surface; and
a notepad assembly, having a substantially flat, generally rectangular inscription member defined by a top surface and a back surface and at least two adhesive pads defined by an adhesive material applied to at least one of their exposed surfaces protruding from said back surface.

9. The combination of claim 8, wherein said assembly further comprises a clip configured to releasibly retain an elongate member extending from said inscription member.

10. The combination of claim 9, wherein said clip is defined by a back surface attached to said top surface, said clip releasable retention feature being an elongate arcuate bore substantially along its length.

11. The combination of claim 10, wherein said top surface is a scratch-resistant material.

12. The combination of claim 11, wherein said adhesive pads comprise a thickened pliable substrate having first and second surfaces, each said surface coated with said adhesive material.

13. The combination of claim 12, comprising four said adhesive pads.

14. The combination of claim 13, wherein one of each said adhesive pads is attached to said back surface of said inscription member adjacent to each of the four corners of said generally rectangular shape.

15. A tape measure notepad assembly, comprising:
a flat, thin, non-curved inscription member defined by a top surface and a back surface; and
at least two adhesive pads defined by an adhesive material applied to at least one of their exposed surfaces protruding from said back surface.

16. The assembly of claim 15, further comprising a clip configured to releasibly retain an elongate member extending from said top surface of said inscription member.

17. The assembly of claim 16, wherein said top surface is a scratch-resistant material.

18. The assembly of claim 17, wherein said adhesive pads comprise a thickened pliable substrate having first and second surfaces, each said surface coated with said adhesive material.

19. The assembly of claim 18, comprising four said adhesive pads.

20. The assembly of claim 19, wherein one of each said adhesive pads is attached to said back surface of said inscription member adjacent to each of the four corners of said generally rectangular shape.
